(19) United States
(12) Patent Application Publication
(10) Pub. No.: US 2010/0026573 A1
(43) Pub. Date: Feb. 4, 2010

(54) ELECTRONIC APPARATUS, RECORDING MEDIUM RECORDING CONTROL PROGRAM AND CONTROL METHOD

(75) Inventor: Tsuyoshi UCHIHARA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/533,261

(22) Filed: Jul. 31, 2009

(30) Foreign Application Priority Data
Aug. 4, 2008 (JP) 2008-200695

(51) Int. Cl. H01Q 3/00

(52) U.S. Cl. 342/368

(57) ABSTRACT

An electronic apparatus having a display screen, a first antenna among a plurality of antennas provided adjacent to the first side and closer to the third side, a second antenna among the plurality of antennas provided adjacent to the second side and closer to the first side, a third antenna among the plurality of antennas provided adjacent to the fourth side and closer to the second side. A control part of the electronic apparatus selects the first antenna and the second antenna as the antennas to be used for radio communication when the first side is an upper side of the display screen, and selects the second antenna and the third antenna when the second side is the upper side of the display screen.

### CROSS-REFERENCE TO RELATED APPLICATIONS

This application is based upon and claims the benefit of priority of the prior Japanese Patent Application No. 2008-200695, filed on Aug. 4, 2008, the entire contents of which are incorporated by reference herein.

### BACKGROUND

1. Field

The present invention is related to an electronic apparatus, recording medium having a program recorded thereon and control method, and more particularly to selectively controlling an antenna(s) to be used.

2. Description of the Related Art

Some types of electronic apparatus(es) including information processing apparatuses, such as laptop computers of tablet type or convertible type have a radio communication function to perform data communication by radio. Such electronic apparatuses may be required to meet SAR (Specific Absorption Rate) specifications for manufacture/sales.

In this connection, a typical portable walkie-talkie use two antennas differently in such a way that, when a sensor detects that a human body approaches the walkie-talkie, radio waves sent out in a direction of the human body are weakened.

Also, a portable radiotelephone terminal device that generally selects an antenna to be used by recognizing an approach of a human body is known.

Also, a mobile communication terminal device that generally selects an antenna to be used by detecting the inclination of a cabinet is known.

In addition, a typical tablet PC of convertible type that controls output of a radiation antenna based on a hinge state and condition(s) of use such as a display state of images has been developed.

### SUMMARY

According to an aspect of the invention, an electronic apparatus includes a cabinet (housing) having a rectangular display screen composed of a first side, a second side adjacent to the first side and continuing from one end of the first side, a third side adjacent to the first side and continuing from the other end of the first side, and a fourth side adjacent to the second side and the third side.

The electronic apparatus of an embodiment may include a first antenna among a plurality of antennas provided adjacent to the first side and closer to the third side, a second antenna among the plurality of antennas provided adjacent to the second side and closer to the first side, a third antenna among the plurality of antennas provided adjacent to the fourth side and closer to the second side, and a control part that selects the first antenna and the second antenna as the antennas to be used for a radio communication when the first side is an upper side of the display screen, and selects the second antenna and the third antenna when the second side is the upper side of the display screen.

The object and advantages of the invention will be realized and attained by means of the element(s) and combination(s) particularly pointed out in the claims.

It is to be understood that both the foregoing general description and the following detailed description are exemplary and explanatory and are not restrictive of the invention, as claimed. Further, additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram showing an overview of an embodiment;

FIG. 2 is a diagram showing an appearance of an information processing apparatus;

FIG. 3 is a diagram showing an appearance of an information processing apparatus;

FIG. 4 is a hardware configuration diagram of an information processing apparatus;

FIG. 5 is a block diagram of an information processing apparatus;

FIG. 6A is a diagram showing condition(s) of use in a tablet state;

FIG. 6B is a diagram showing another condition(s) of use in a tablet state;

FIG. 7A is a diagram showing relations between screen display orientation(s) and antenna position(s);

FIG. 7B is a diagram showing relation(s) between screen display orientation(s) and antenna position(s);

FIG. 8A is a diagram showing relation(s) between screen display orientation(s) and antenna position(s);

FIG. 8B is a diagram showing relation(s) between screen display orientation(s) and antenna position(s);

FIG. 9 is a diagram showing a data structure example of an output antenna table;

FIG. 10 is a flow chart showing a procedure for output antenna setting processing; and

FIG. 11 is a flow chart showing a procedure for output antenna setting processing.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

An embodiment will be described below with reference to the drawings.

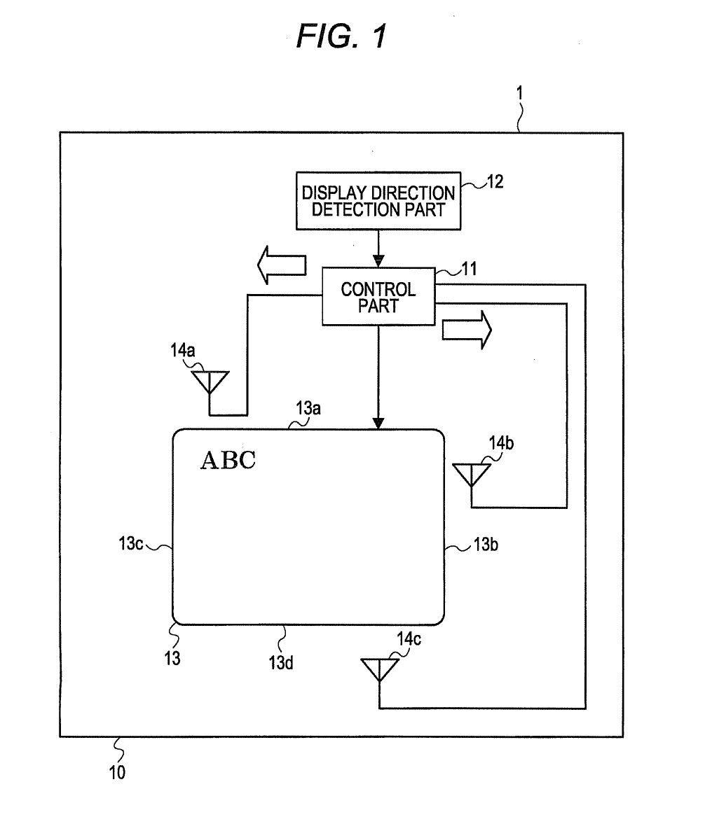

FIG. 1 is a diagram showing an overview of an embodiment. An electronic apparatus 1 shown in FIG. 1 has a function to display images or any other information and perform radio communication. The electronic apparatus 1 has a cabinet 10, a control part 11, a display direction detection part 12, and a plurality of antennas (a first antenna 14a, a second antenna 14b, and a third antenna 14c).

The cabinet (housing) 10 has a display screen 13. The display screen 13 is rectangular and has a first side 13a, a second side 13b adjacent to the first side 13a and continuing from one end of the first side 13a, a third side 13c adjacent to the first side 13a and continuing from the other end of the first side 13a, and a fourth side 13d adjacent to the second side 13b and the third side 13c.

A first antenna 14a is one of a plurality of antennas held by the electronic apparatus 1 and is provided adjacent to the first side 13a and closer to the third side 13c relative to the other sides of the display screen 13.

A second antenna 14b is also one of the plurality of antennas held by the electronic apparatus 1 and is provided adjacent to the second side 13b and closer to the first side 13a with respect to the remaining sides of the display screen 13.

A third antenna 14c is also one of the plurality of antennas held by the electronic apparatus 1 and is provided adjacent to the fourth side 13d and closer to the second side 13b with respect to the other sides of the display screen 13.

The control part 11 selects the first antenna 14a and the second antenna 14b as antennas to be used for radio communication when the first side 13a is an upper side of the display screen 13 based on a display direction of a display image displayed in the display screen 13 detected by the display direction detection part 12, and selects the second antenna 14b and the third antenna 14c when the second side 13b is the upper side of the display screen 13.

Based on the selection of antennas by the control part 11, radio waves used for radio communication are output. Since, at this point, antennas positioned in the upper part of the display screen 13 viewed from a user are selected by the control part 11, radio waves are output from antennas away from the body of the user, instead of radio waves being output from antennas closer to the body of the user.

In this way, the electronic apparatus 1 ensures satisfactory radio communication while meeting standards for safety of radio waves to enable the user to use the apparatus more comfortably.

An embodiment is described below in detail with reference to the drawings.

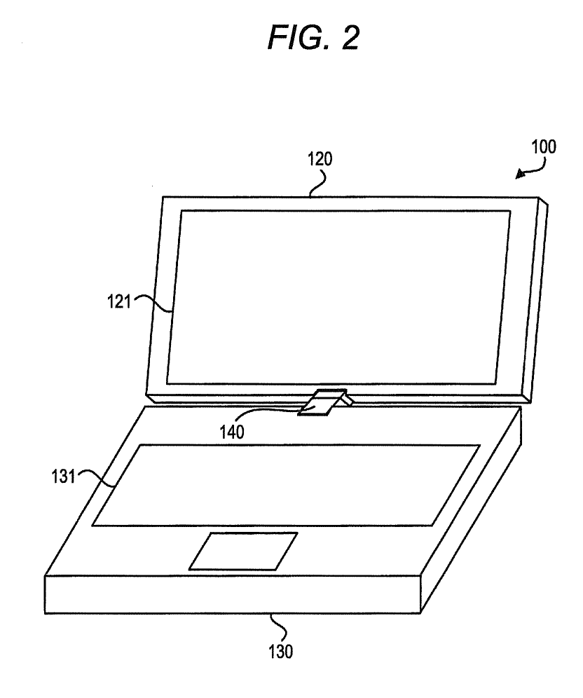

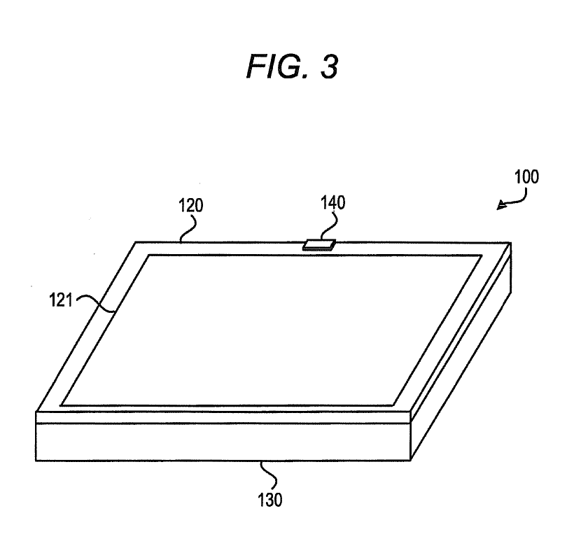

FIGS. 2 and 3 are diagrams showing an appearance of an information processing apparatus. FIG. 2 shows a diagram of an information processing apparatus 100 when a display part 120 is opened (normal condition of use). FIG. 3 shows a diagram of the information processing apparatus 100 when the display part 120 is closed with an LCD (Liquid Crystal Monitor) 121 facing upward (tablet state).

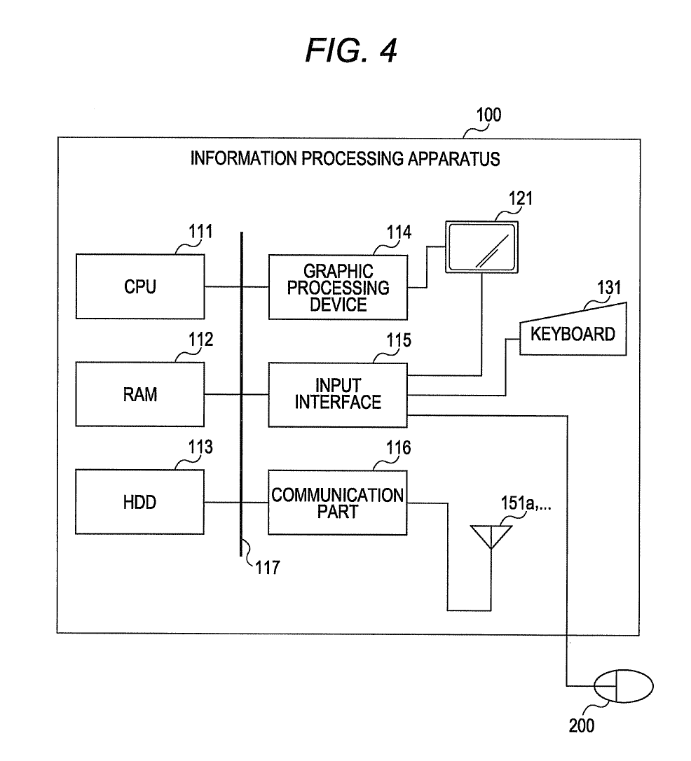

The information processing apparatus 100 shown in FIGS. 2 and 3 has a radio communication function and is a laptop PC of convertible type capable of converting into (switching between) a normal condition of use, a tablet state, and a housed state. The information processing apparatus 100 has the display part 120 having the LCD 121 and an antenna A 151 a and the like described in detail below in FIG. 4, a body part 130 having a keyboard 131 and electronic components such as a CPU 111 described later in FIG. 4, and a coupling part 140.connecting the display part 120 and the body part 130.

The LCD 121 is a display device having a display screen for displaying characters, images and/or other information. In addition to the LCD, other thin display devices such as an organic electroluminescence (EL) display may also be used.

The keyboard 131 is an input device used for performing character input and other operation(s).

The coupling part 140 has an opening/closing axis (not shown) securely coupled to the display part 120 and the body part 130 and a rotation axis (not shown) intersecting the opening/closing axis and relatively rotatably coupled to the display part 120 and the body part 130. The information processing apparatus 100 can be converted into at least three states of a normal condition of use shown in FIG. 2, a tablet state shown in FIG. 3, and a housed state in which the display part 120 is closed with the LCD 121 directed inward, by the opening/closing axis and the rotation axis of the coupling part 140.

The information processing apparatus 100 according to an embodiment has been described by taking a laptop PC of convertible type as an example, but the present invention is not limited to this and may be a laptop PC of tablet type in which a display part and a body part are integrated or fixed so that the laptop PC is always used in a tablet state. Alternatively, the information processing apparatus 100 may be a laptop PC of other types or an electronic apparatus having a display function and a radio communication function such as a portable information terminal device other than the laptop PC.

Next, a hardware configuration of an embodiment will be described.

FIG. 4 is a hardware configuration diagram of an information processing apparatus.

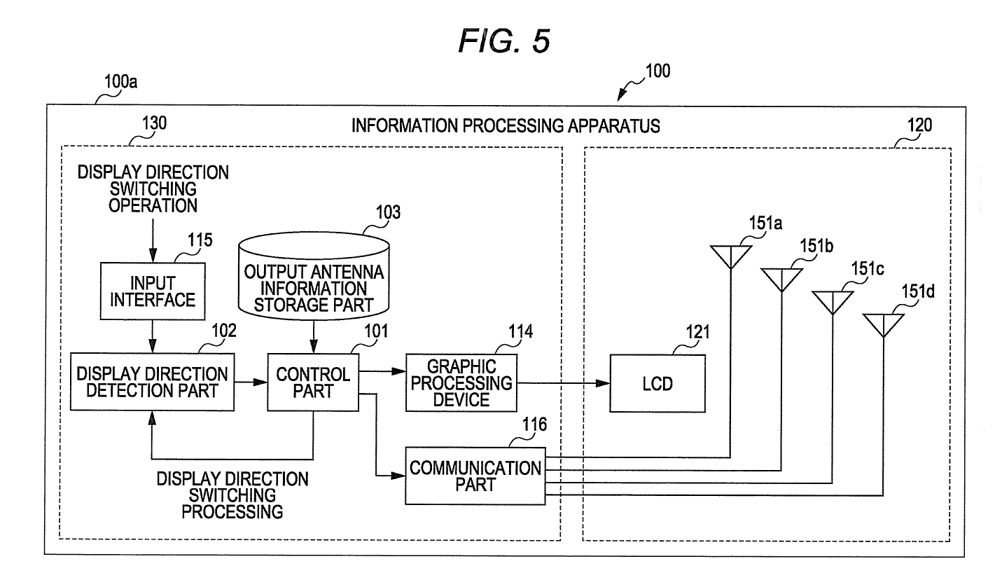

The information processing apparatus 100 is controlled as a whole by the CPU (Central Processing Unit) 111. A RAM (Random Access Memory) 112, an HDD (Hard Disk Drive) 113, a graphic processing device 114, an input interface 115, and a communication part 116 are connected with the CPU 11 via a bus 117. The antenna A 151a and the like are connected with the communication part 116, which is described in detail with respect to FIG. 5.

In the RAM 112, at least part of an OS program and application(s) executed by the CPU 111 is temporarily stored. In addition, various kinds of data necessary for processing by the CPU 111 are stored in the RAM 112.

In the HDD 113, data handled by the OS and applications in the information processing apparatus 100 is stored.

Display devices such as the LCD 121 can be connected with the graphic processing device 114. The graphic processing device 114 can cause the display screen of the display device such as the LCD 121 to display information including images according to instruction(s) from the CPU 111. Moreover, the graphic processing device 114 and the LCD 121 are connected, for example, by a serial communication cable so that control signals and image signals are mutually transmitted and received.

An input device such as the keyboard 131, a mouse 200, and the LCD 121 can be connected with the input interface 115. The input interface 115 outputs signals, transmitted from the input device such as the keyboard 131, to the CPU 111 via the bus 117.

The communication part 116 includes an RF (Radio Frequency) circuit and a modulation/demodulation circuit of transmission/reception signals for radio communication and transmits/receives data by a wireless LAN (Wireless Local Area Network) or the like via the antenna 151a. In the information processing apparatus 100, data is transmitted/received by performing radio communication via the antenna 151a and the like.

The LCD 121 can display information according to the operation of the information processing apparatus 100. The LCD 121 can also accept input by the user, for example, character input and the selection of an icon displayed on the display surface by detecting the touch of a touch pen on the display surface through detection of a change in pressure or static electricity on the display surface provided on the surface.

With the hardware configuration described above, processing function(s) according to an embodiment can be realized.

Next, a module configuration of an embodiment will be described.

FIG. 5 is a block diagram of an information processing apparatus. The information processing apparatus 100 shown in FIG. 5 has a function to display information including images and a function to perform radio communication. The information processing apparatus 100 has a cabinet (housing) 100a. The cabinet 100a has the display part 120, the body part 130, and the coupling part 140 (FIGS. 2 and 3). The display part 120 has the LCD 121, the antenna A 151a, an antenna B 151b, an antenna C 151c, and an antenna D 151d. The body part 130 has a control part 101, a display direction detection part 102, an output antenna information storage part 103, the graphic processing device 114, the input interface 115, and the communication part 116.

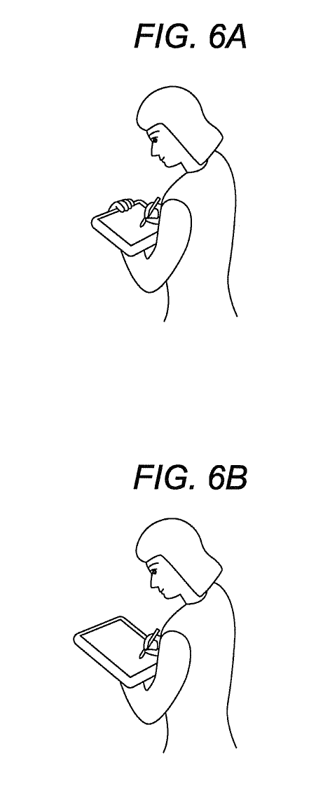

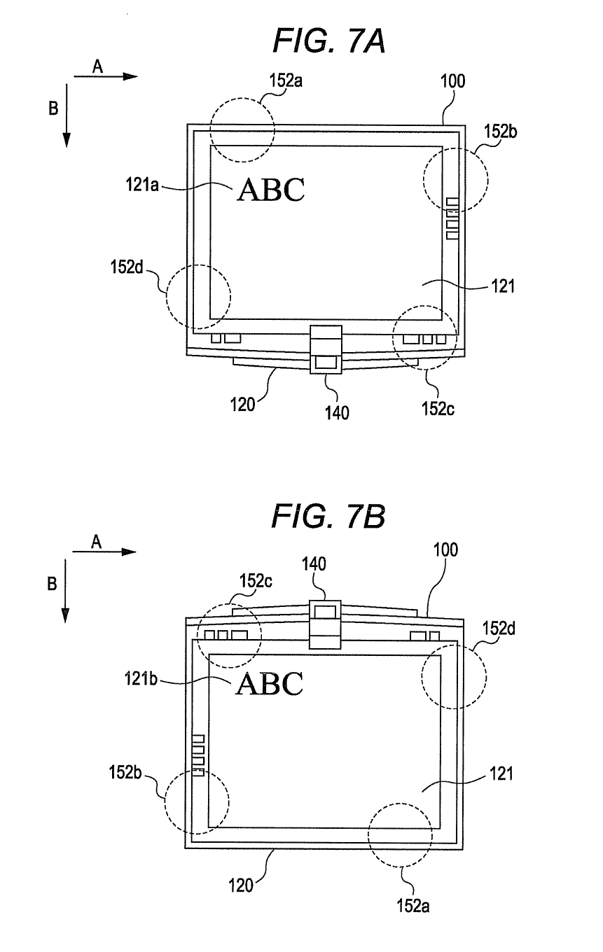

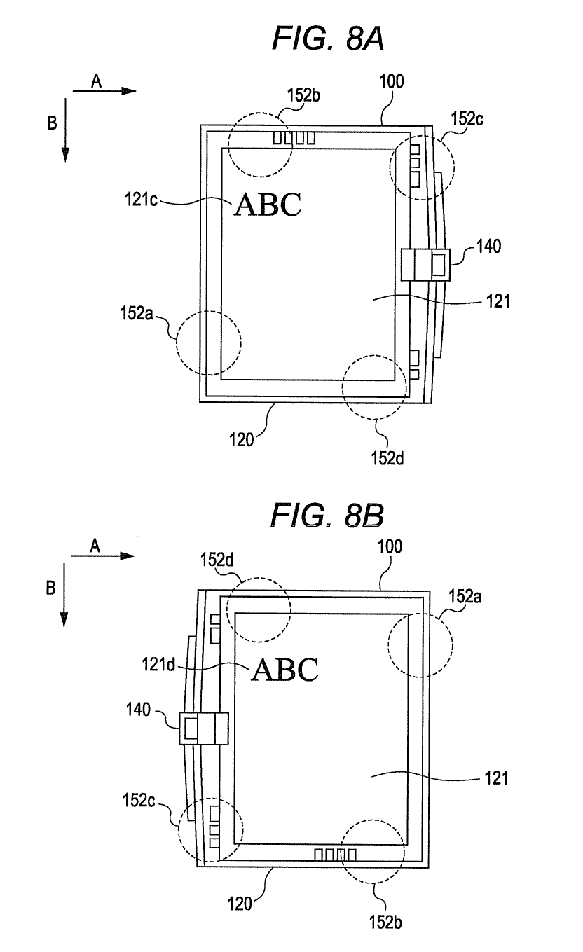

The control part 101 selects the antenna A 151a and the antenna B 151b as antennas to be used for radio communication in primary landscape orientation based on the display direction of a display image displayed in the LCD 121 detected by the display direction detection part 102. Similarly, the control part 101 selects the antenna B 151b and the antenna C 151c in primary portrait orientation (see FIGS. 6 and 7). The control part 101 selects the antenna A 151a and the antenna D 151d as antennas to be used for radio communication in secondary portrait orientation (see FIG. 8). The control part 101 selects the antenna C 151c and the antenna D 151d as antennas to be used for radio communication in secondary landscape orientation (see FIG. 7).

The control part 101 controls the communication part 116 to cause antennas selected as antennas to be used for radio communication to output radio waves used for radio communication.

The control part 101 also controls the graphic processing device 114 to perform switching processing to switch the display direction of the display screen displayed in the LCD 121 (described in FIG. 2). By detecting the switching processing being performed, the display direction detection part 102 detects the display direction of the display screen.

The display direction detection part 102 detects the display direction of the display screen by detecting switching processing being performed by the control part 101. The display direction detection part 102 also detects the display direction of the display screen by detecting a switching operation to input the display direction to be switched by operating an operation part such as the keyboard 131, the LCD 121, and the mouse 200 by the user via the input interface, 151.

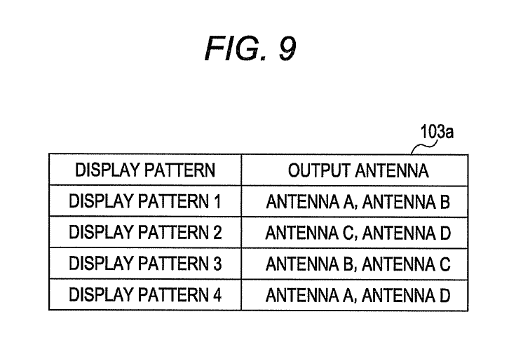

The output antenna information storage part 103 stores output antenna information associating the display direction of the display screen and antennas to be used for radio communication for the display direction. Details of the output antenna information will be described in FIG. 9.

The communication part 116 has a changeover switch to switch antennas to output radio waves used for radio communication. Accordingly, the communication part 116 outputs radio waves to perform radio communication from the antennas selected by the control part 101 under the control of the control part 101.

The LCD 121, whose details is described in detail below in FIGS. 7 and 8, is a rectangular display screen.

The coupling part 140 closably couples the display part 120 and the body part 130 by an opening/closing axis and also rotatably couples these by a rotation axis in a direction intersecting the opening/closing axis.

The antenna A 151a is one of a plurality of antennas held by the information processing apparatus 100 and, while details thereof is described below in association with FIG. 7, is provided at a position adjacent to the upper side of the LCD 121 and closer to the left side thereof in primary landscape orientation (see FIGS. 6 and 7).

The antenna B 151b is also one of the plurality of antennas held by the information processing apparatus 100 and, while details thereof is described below in association with FIG. 7, is provided at a position adjacent to the right side of the LCD 121 and closer to the upper side thereof in primary landscape orientation.

The antenna C 151c is also one of the plurality of antennas held by the information processing apparatus 100 and, while details thereof is described below in association with FIG. 7, is provided at a position adjacent to the lower side of the LCD 121 and closer to the right side thereof in primary landscape orientation.

The antenna D 151d is also one of the plurality of antennas held by the information processing apparatus 100 and, while details thereof is described below in association with FIG. 7, is provided at a position adjacent to the left side of the LCD 121 and closer to the lower side thereof in primary landscape orientation.

In the information processing apparatus 100 according to an embodiment, the communication part 116 is controlled based on the selection of antennas by the control part 101 and radio waves used for radio communication are output from the selected antennas. At this point, antennas positioned in the upper part of the LCD 121 viewed from the user are selected by the control part 101 and thus, radio waves are output from antennas away from the body of the user, instead of radio waves being output from antennas closer to the body of the user.

Next, condition(s) of use of an embodiment will be described.

FIGS. 6A and 6B are diagrams showing conditions of use in a tablet state. FIG. 6A shows a condition of use in a primary landscape orientation. FIG. 6B shows a condition of use in a primary portrait orientation.

When the information processing apparatus 100 is used in a tablet state, the LCD 121 can be used longitudinally and also transversely by switching the orientation of images (information) to be displayed.

When information such as an image displayed in the LCD 121 is horizontally oriented (when the longitudinal direction of the LCD 121 is the horizontal direction when viewed from the user), the LCD 121 is in landscape orientation. When an image displayed in the LCD 121 is vertically oriented (when the longitudinal direction of the LCD 121 is the vertical direction when viewed from the user), the LCD 121 is in portrait orientation.

Details are described below in association with FIG. 7, but when, as shown in FIG. 6A, the coupling part 140 is positioned below in landscape orientation, the orientation is called primary landscape in the information processing apparatus 100. When the coupling part 140 is positioned above in landscape orientation, the orientation is called secondary landscape.

Details are described below in association with FIG. 8, but when, as shown in FIG. 6B, the coupling part 140 is positioned on a right side when viewed from the user in portrait orientation, the orientation is called primary portrait in the information processing apparatus 100. When the coupling part 140 is positioned on a left side when viewed from the user in portrait orientation, the orientation is called secondary portrait.

FIGS. 7 and 8 are diagrams showing relations between screen display orientations and antenna positions. FIG. 7 shows antenna positions when the display part 120 of the information processing apparatus 100 is in landscape orientation. FIG. 8 shows antenna positions when the display part 120 of the information processing apparatus 100 is in portrait orientation. Here, in each of FIGS. 7A to 8B, the orientation indicated by an arrow A is defined as right and that indicated by an arrow B as downward.

FIG. 7A shows, when the information processing apparatus 100 is arranged so that the longitudinal direction of the LCD 121 is the horizontal direction relative to the orientation of a screen display 121a displaying of characters “ABC” shown as an example, an antenna A arrangement position 152a to an antenna D arrangement position 152d as positions where the antenna A 151a to the antenna D 151d (see FIG. 5) are arranged in the display part 120 in primary landscape orientation in which the coupling part 140 is positioned below. Positions where the antenna A 151a, the antenna B 151b, the antenna C 151c, and the antenna D 151d are arranged are defined as the antenna A arrangement position 152a, the antenna B arrangement position 152b, the antenna C arrangement position 152c, and the antenna D arrangement position 152d, respectively.

The antenna A arrangement position 152a where the antenna A 151a is arranged in primary landscape orientation is positioned, as shown in FIG. 7A, on the upper side of the LCD 121 closer to the left side of the LCD 121 adjacent to the left of the upper side.

Similarly, the antenna B arrangement position 152b where the antenna B 151b is arranged is positioned on the right side of the LCD 121 adjacent to the right of the upper side of the LCD 121 and closer to the upper side. The antenna C arrangement position 152c where the antenna C 151c is arranged is positioned on the lower side of the LCD 121 opposite to the upper side of the LCD 121 and adjacent to the right side of the LCD 121 and the left side of the LCD 121 and closer to the right side. The antenna D arrangement position 152d where the antenna D 151d is arranged is positioned on the left side of the LCD 121 adjacent to the left of the upper side of the LCD 121 and closer to the lower side of the LCD 121.

At this point, the information processing apparatus 100 does not use the antenna C 151c arranged at the antenna C arrangement position 152c closest to the human body and instead, uses the antenna A 151a and the antenna B 151b to perform radio communication. Accordingly, when the user uses the information processing apparatus 100 as shown in FIG. 6A (primary landscape orientation), the antenna A 151a and the antenna B 151b from which radio waves are output are arranged at the antenna A arrangement position 152a and the antenna B arrangement position 152b, respectively, which are away from the user's body. Thus, the amount of radio waves radiated toward the human body can be reduced in primary landscape orientation while the amount of radio waves necessary for radio communication is output.

FIG. 7B shows, when the information processing apparatus 100 is arranged so that the longitudinal direction of the LCD 121 is the horizontal direction relative to the orientation of a screen display 121b, the antenna A arrangement position 152a to the antenna D arrangement position 152d as positions where each antenna is arranged in the display part 120 in secondary landscape orientation in which the coupling part 140 is positioned above.

The antenna A arrangement position 152a in secondary landscape orientation is positioned, as shown in FIG. 7B, on the lower side of the LCD 121 closer to the right side of the LCD 121 adjacent to the right of the lower side.

Similarly, the antenna B arrangement position 152b is positioned on the left side of the LCD 121 adjacent to the left of the lower side of the LCD 121 and closer to the lower side. The antenna C arrangement position 152c is positioned on the upper side of the LCD 121 opposite to the lower side of the LCD 121 and adjacent to the right side of the LCD 121 and the left side of the LCD 121 and closer to the left side. The antenna D arrangement position 152d is positioned on the right side of the LCD 121 adjacent to the right of the lower side of the LCD 121 and closer to the upper side of the LCD 121.

At this point, the information processing apparatus 100 does not use the antenna A 151a arranged at the antenna A arrangement position 152a closest to the human body and instead, uses the antenna C 151d and the antenna D 151d to perform radio communication. Accordingly, when the user uses the information processing apparatus 100 with the vertical orientation thereof reversed to that in FIG. 6A in secondary landscape orientation, the antenna C 151c and the antenna D 151d from which radio waves are output are arranged at the antenna C arrangement position 152c and the antenna D arrangement position 152d, respectively, which are away from the user's body. Thus, the amount of radio waves radiated toward the human body can be reduced in secondary landscape orientation while the amount of radio waves necessary for radio communication is output.

FIG. 8A shows, when the information processing apparatus 100 is arranged so that the longitudinal direction of the LCD 121 is a vertical direction relative to the orientation of a screen display 121c, the antenna A arrangement position 152a to the antenna D arrangement position 152d as positions where each antenna is arranged in the display part 120 in primary portrait orientation in which the coupling part 140 is positioned on the right.

The antenna A arrangement position 152a in primary portrait orientation is positioned, as shown in FIG. 8A, on the left side of the LCD 121 closer to the lower side of the LCD 121 adjacent to the bottom of the left side.

Similarly, the antenna B arrangement position 152b is positioned on the upper side of the LCD 121 adjacent to the top of the left side of the LCD 121 and closer to the left side. The antenna C arrangement position 152c is positioned on the right side of the LCD 121 opposite to the left side of the LCD 121 and adjacent to the upper side of the LCD 121 and the lower side of the LCD 121 and closer to the upper side. The antenna D arrangement position 152d is positioned on the lower side of the LCD 121 adjacent to the bottom of the left side of the LCD 121 and closer to the right side of the LCD 121.

At this point, the information processing apparatus 100 does not use the antenna D 151d arranged at the antenna D arrangement position 152d closest to the human body and instead, uses the antenna B 151b and the antenna C 151c to perform radio communication. Accordingly, when the user uses the information processing apparatus 100 as shown in FIG. 6B (primary portrait orientation), the antenna B 151b and the antenna C 151c from which radio waves are output are arranged at the antenna B arrangement position 152b and the antenna C arrangement position 152c, respectively, which are away from the user's body. Thus, the amount of radio waves radiated toward the human body can be reduced in primary portrait orientation while the amount of radio waves necessary for radio communication is output.

FIG. 8B shows, when the information processing apparatus 100 is arranged so that the longitudinal direction of the LCD 121 is a vertical direction relative to the orientation of a screen display 121d, the antenna A arrangement position 152a to the antenna D arrangement position 152d as positions where each antenna is arranged in the display part 120 in secondary portrait orientation in which the coupling part 140 is positioned on the left.

The antenna A arrangement position 152a in secondary portrait orientation is positioned, as shown in FIG. 8B, on the right side of the LCD 121 closer to the upper side of the LCD 121 adjacent to the top of the right side.

Similarly, the antenna B arrangement position 152b is positioned on the lower side of the LCD 121 adjacent to the bottom of the right side of the LCD 121 and closer to the right side. The antenna C arrangement position 152c is positioned on the left side of the LCD 121 opposite to the right side of the LCD 121 and adjacent to the upper side of the LCD 121 and the lower side of the LCD 121 and closer to the lower side. The antenna D arrangement position 152d is positioned on the upper side of the LCD 121 adjacent to the top of the right side of the LCD 121 and closer to the left side of the LCD 121.

At this point, the information processing apparatus 100 does not use the antenna B 151b arranged at the antenna B arrangement position 152b closest to the human body and instead, uses the antenna A 151a and the antenna D 151d to perform radio communication. Accordingly, when the user uses the information processing apparatus 100 with the horizontal orientation thereof reversed to that in FIG. 6B in secondary portrait orientation, the antenna A 151a and the antenna D 151d from which radio waves are output are arranged at the antenna A arrangement position 152a and the antenna D arrangement position 152d, respectively, which are away from the user's body. Thus, the amount of radio waves radiated toward the human body can be reduced in secondary portrait orientation while the amount of radio waves necessary for radio communication is output.

Next, a data structure example of data used in an embodiment will be described.

FIG. 9 is a diagram showing a data structure example of an output antenna table. An output antenna table 103a shown in FIG. 9 is created and managed by the information processing apparatus 100 and stored in the HDD 113 (see FIG. 4) functioning as the output antenna information storage part 103 (see FIG. 5). The output antenna table 103a is a table to store output antenna information showing the correspondence between a display pattern and output antennas.

The output antenna table 103a has “Display pattern”, which is an item showing a display direction of the display screen of the LCD 121, and “Output antenna”, which is an item showing an antenna from which radio waves used for radio communication are output, provided therein. Information arranged in the horizontal direction of each item is mutually associated to constitute output antenna information.

The display pattern is information to indicate the display direction of display information including images to be displayed in the display screen of LCD. In the example shown in FIG. 9, Display pattern 1 is concretely the primary landscape orientation (see FIG. 7A). Similarly, Display pattern 2 is the secondary landscape orientation (see FIG. 7B). Display pattern 3 is the primary portrait orientation (see FIG. 8A). Display pattern 4 is the secondary portrait orientation (see FIG. 8B).

Output antennas show antennas from which radio waves used for radio communication are output in each display pattern. As output antennas, those antennas that are away from the user's body in each display pattern so that an influence of output radio waves on the user is relatively small are set.

Next, processing performed in an embodiment will be described.

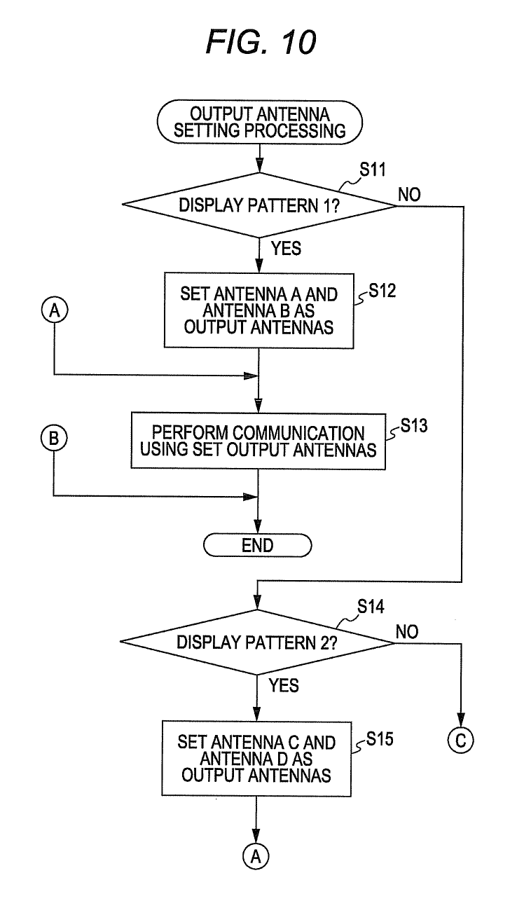

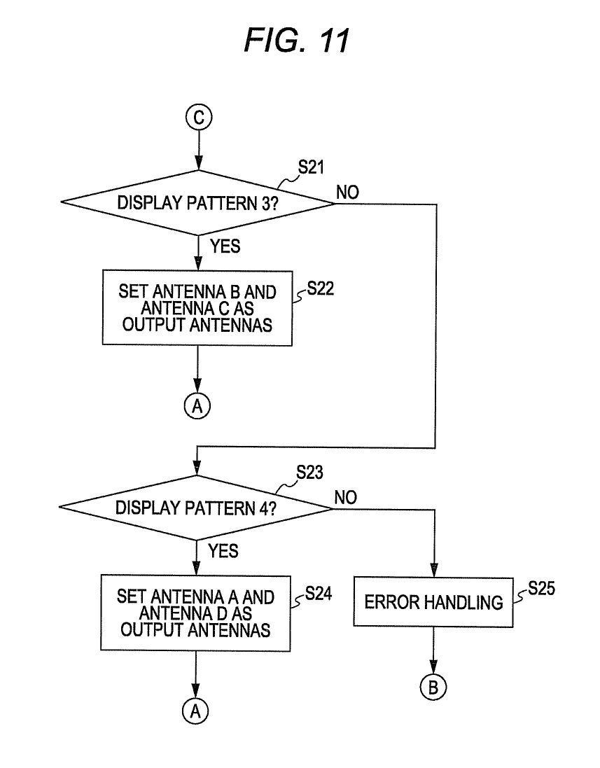

FIGS. 10 and 11 are flow charts showing procedures for output antenna setting processing.

The information processing apparatus 100 in an embodiment sets (configures) output antennas based on the display direction of the display screen of the LCD 121 in the information processing apparatus 100 by performing output antenna setting processing and performs radio communication using the set antennas. The display direction of the LCD 121 is monitored at all times or at regular intervals by the information processing apparatus 100 for any change and, when the display direction detection part 102 (see FIG. 5) detects a change of the display direction, the screen setting processing is invoked, which is then performed by the information, processing apparatus 100. The output antenna setting processing is described below.

Operation S11 The control part 101 determines whether the display direction detected by the display direction detection part 102 corresponds to Display pattern 1 (primary landscape orientation). If the display direction corresponds to Display pattern 1, the control part 101 proceeds to Operation S12. If, on the other hand, the display direction does not correspond to Display pattern 1, the control part 101 proceeds to Operation S14.

Operation S12 The control part 101 acquires output antenna information (described in FIG. 9) from the output antenna information storage part 103 and sets the antenna A 151a and the antenna B 151b, which are output antennas corresponding to Display pattern 1, as output antennas.

Operation S13 Then, the communication part 116 performs radio communication using the output antennas set by the control part 101 based on the display pattern and output antenna information. Subsequently, the control part 101 terminates processing.

Operation S14 The control part 101 determines whether the display direction detected by the display direction detection part 102 corresponds to Display pattern 2 (secondary landscape orientation). If the display direction corresponds to Display pattern 2, the control part 101 proceeds to Operation S15. If, on the other hand, the display direction does not correspond to Display pattern 2, the control part 101 proceeds to Operation S21 (see FIG. 11).

Operation S15 The control part 101 acquires output antenna information from the output antenna information storage part 103 and sets the antenna C 151c and the antenna D 151d, which are output antennas corresponding to Display pattern 2, as output antennas. Subsequently, the control part 101 proceeds to Operation S13.

Operation S21 The control part 101 determines whether the display direction detected by the display direction detection part 102 corresponds to Display pattern 3 (primary portrait orientation). If the display direction corresponds to Display pattern 3, the control part 101 proceeds to Operation S22. If, on the other hand, the display direction does not correspond to Display pattern 3, the control part 101 proceeds to Operation S23.

Operation S22 The control part 101 acquires output antenna information from the output antenna information storage part 103 and sets the antenna B 151b and the antenna C 151c, which are output antennas corresponding to Display pattern 3, as output antennas. Subsequently, the control part 101 proceeds to Operation S13 (see FIG. 10).

Operation S23 The control part 101 determines whether the display direction detected by the display direction detection part 102 corresponds to Display pattern 4 (secondary portrait orientation). If the display direction corresponds to Display pattern 4, the control part 101 proceeds to Operation S24. If, on the other hand, the display direction does not correspond to Display pattern 4, the control part 101 proceeds to Operation S25.

Operation S24 The control part 101 acquires output antenna information from the output antenna information storage part 103 and sets the antenna A 151a and the antenna D 151d, which are output antennas corresponding to Display pattern 4, as output antennas. Subsequently, the control part 101 proceeds to Operation S13 (FIG. 10).

Operation S25 The control part 101 handles errors when the display pattern is determined to be none of Display pattern 1 to Display pattern 4. Then, the control part 101 terminates processing. In the error handling, the control part 101 does not change settings of the previous output antennas and performs radio communication using the same output antennas as before. However, error handling is not limited to this and output of radio waves from all antennas may be stopped in error handling. Alternatively, a notification of error in display pattern determination may be made by an error display or error sound output. Alternatively, combined processing of the above processing may be performed.

According to the information processing apparatus 100 in an embodiment, as described above, satisfactory radio communication is ensured while meeting standards for safety of radio waves so that the user is enabled to use the apparatus more comfortably.

Moreover, no special sensor is needed for determining the display direction and therefore, the information processing apparatus 100 is more economical.

When compared with the laptop PC of tablet type that suppresses radio waves radiated to the user's body by fixing the antenna position and the display direction of images, the information processing apparatus 100 is more convenient for the user because the user can freely change the display direction of images, leading to an extended range of use of the information processing apparatus 100.

Since a plurality of antennas arranged apart from a human body can be used, diversity transmission/reception can be performed without being limited by the display direction.

The information processing apparatus 100 in an embodiment has antennas arranged at four locations of the display part 120. However, the present invention is not limited to this and the information processing apparatus 100 may have antennas arranged at three locations of the display part 120 or at five or more locations of the display part 120.

The above processing function can be realized by a computer. In that case, a program describing processing content of functions that the information processing apparatus 100 should have is provided. By executing the program on a computer, the processing functions are realized on the computer.

A program describing processing content can be recorded in a computer-readable recording medium. Examples of the computer-readable recording medium include a magnetic recording device, optical disk, magneto-optical recording medium, and semiconductor memory. Examples of the magnetic recording device include an HDD, flexible disk (FD), and magnetic tape (MT). Examples of the optical disk include a DVD (Digital Versatile Disc), DVD-RAM, CD-ROM (Compact Disc-Read Only Memory), and CD-R (Recordable)/RW (ReWritable). Examples of the magneto-optical recording medium include an MO (Magneto-Optical disk).

When the program is to be distributed, for example, portable recording media such as DVD and CD-ROM in which the program is recorded are sold. Alternatively, the program can be transferred from a server computer to other computers by storing the program on the server computer.

A computer that executes the program stores the program recorded in a portable recording medium or transferred from a server computer in a storage device of the computer. Then, the computer reads the program from the storage device of the computer and performs processing according to the program. Incidentally, the computer may read the program directly from a portable recording medium to perform processing according to the program. Alternatively, each time a program is transferred from a server computer, the computer may sequentially perform processing according to the received program.

In the foregoing, the disclosed electronic apparatus, control program, and control method have been described based on the illustrated embodiment, but the configuration of each part may be replaced by any configuration having a similar function. Any other construct or process may be added to the disclosed technique. The disclosed technique may be a combination of two or more configurations in the above embodiment.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The foregoing shows only the principle of the present invention. A large number of modifications and alterations can be made by those skilled in the art and the disclosed technique is not limited to the exact configurations and application examples shown and described above, and all corresponding modifications and equivalents are considered to be within the scope of the present invention based on appended claims and equivalents.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention, the scope of which is defined in the claims and their equivalents.

What is claimed is:

1. An electronic apparatus, comprising:
a cabinet having a rectangular display screen composed of a first side, a second side adjacent to the first side and continuing from one end of the first side, a third side adjacent to the first side and continuing from another end of the first side, and a fourth side adjacent to the second side and the third side;
a first antenna among a plurality of antennas provided adjacent to the first side and closer to the third side;
a second antenna among the plurality of antennas provided adjacent to the second side and closer to the first side;
a third antenna among the plurality of antennas provided adjacent to the fourth side and closer to the second side; and
a control part that selects the first antenna and the second antenna as antennas to be used for a radio communication when the first side is an upper side of the display screen, and selects the second antenna and the third antenna when the second side is the upper side of the display screen.

2. The electronic apparatus according to claim 1, comprising:
a fourth antenna among the plurality of antennas provided adjacent to the third side and closer to the fourth side, and
wherein the control part selects the first antenna and the fourth antenna as the antennas to be used for the radio communication when the third side is the upper side of the display screen.

3. The electronic apparatus according to claim 2, wherein the control part selects the third antenna and the fourth antenna as the antennas to be used for the radio communication when the fourth side is the upper side of the display screen.

4. The electronic apparatus according to claim 1, wherein the cabinet comprises:
a first cabinet having the display screen and the plurality of antennas;
a second cabinet; and
a coupling part that closably couples the first cabinet and the second cabinet by a first axis and rotatably couples the first cabinet and the second cabinet by a second axis in a direction intersecting the first axis.

5. The electronic apparatus according to claim 1, comprising:
a display direction detection part that detects a display direction of the display screen, and
wherein the control part selects, based on a detection result by the display direction detection part, the first antenna and the second antenna as the antennas to be used for the radio communication when the first side is the upper side of the display screen, and selects the second antenna and the third antenna when the second side is the upper side of the display screen.

6. The electronic apparatus according to claim 5, wherein the display direction detection part detects the display direction of the display screen by detecting a switching operation to input the display direction to be switched by an operation part being operated by a user.

7. The electronic apparatus according to claim 5, wherein the control part performs a switching processing to switch the display direction of the display screen, and
the display direction detection part detects the display direction of the display screen by detecting the switching processing being performed by the control part.

8. The electronic apparatus according to claim 1, comprising:
an output antenna information storage part that stores output antenna information associating a display direction of the display screen and the antennas to be used for the radio communication in the display direction.

9. A computer-readable recording medium having recorded therein a control program executed by an electronic apparatus, comprising:
detecting a display direction of a display screen of the electronic apparatus, the display screen having a first side, a second side adjacent to the first side and continuing from one end of the first side, a third side adjacent to the first side and continuing from another end of the first side, and a fourth side adjacent to the second side and the third side;
selecting, based on a result of the detection, a first antenna provided adjacent to the first side and closer to the third side and a second antenna provided adjacent to the second side and closer to the first side as antennas to be used for a radio communication when the first side is an upper side of the display screen; and
selecting the second antenna and the third antenna provided adjacent to the fourth side and closer to the second side when the second side is the upper side of the display screen.

10. A control method for controlling an electronic apparatus, comprising:
detecting a display direction of a display screen, the display screen having a first side, a second side adjacent to the first side and continuing from one end of the first side, a third side adjacent to the first side and continuing from another end of the first side, and a fourth side adjacent to the second side and the third side;
selecting, based on a result of the detection, a first antenna provided adjacent to the first side and closer to the third side and a second antenna provided adjacent to the second side and closer to the first side as antennas to be used for a radio communication when the first side is an upper side of the display screen; and
selecting the second antenna and the third antenna provided adjacent to the fourth side and closer to the second side when the second side is the upper side of the display screen.

11. A computer-implemented method of controlling an electronic device, comprising:
determining an orientation of a display screen; and
switching an antenna for use from among plurality of antennas based the orientation of the display screen determined.
